(19) United States
(12) Patent Application Publication
(10) Pub. No.: US 2021/0039980 A1
(43) Pub. Date: Feb. 11, 2021

(54) RECYCLING

(71) Applicant: KNAUF INSULATION SPRL, Vise (BE)

(72) Inventors: Mitja ORESNIK, Skofja Loka (SI); Gerard DEMOTT, Majcichov (SK)

(21) Appl. No.: 16/967,719

(22) PCT Filed: Feb. 6, 2019
(86) PCT No.: PCT/EP2019/052900

§ 371 Date: Aug. 5, 2020

(30) Foreign Application Priority Data
Feb. 7, 2018 (GB) 1801977.8

(51) Int. Cl. C03C 1/00; C03C 3/087; C03B 1/00; C03C 3/091; C03C 3/083; C03C 3/064; C03B 5/235; C03C 3/085; C03C 3/062

(52) U.S. Cl. CPC C03C 1/002; C03C 3/087; C03B 1/00; C03C 3/091; C03B 2211/22; C03C 3/064; C03B 5/2356; C03C 3/085; C03C 3/062; C03C 3/083

(57) ABSTRACT

A method of recycling a composite material which comprises a mineral portion maintained within a thermoset resin, wherein the thermoset resin makes up at least 30 wt % of the composite material; and wherein the mineral portion makes up at least 30 wt % of the composite material comprises: introducing the composite material in granulated form into a mineral melt in a submerged combustion melter; providing additional heat energy to the mineral melt by combustion of the thermoset resin of the composite material within the mineral melt; and melting and incorporating the mineral portion of the composite material in the mineral melt by heat transfer from the mineral melt.

This invention relates to recycling of composite materials comprising a resin portion, notably a thermoset resin portion, and a mineral portion.

Thermoset composite materials are used in a wide range of applications including construction, transportation, aerospace, appliances and electrical components. At the lower end in terms of cost and performance, polyester resins are combined with short reinforcement glass fibres and low-cost fillers to produce moulding compounds for applications where high mechanical properties are not required. For more demanding uses, continuous carbon or glass fibres and high-performance thermosetting resins, for example epoxy resins, are used. In Europe, approximately 1 million metric tons of thermoset composites are manufactured each year. Although there are many successful uses for thermoset composite materials, recycling at the end of the life cycle is a complication; perceived lack of recyclability is a barrier to the development or even continued use of these materials in some markets. The lack of re-processing capability and the fact that composite materials are always mixtures of components present particular difficulties, notably as there are very few standard formulations and the type and proportions of resin, reinforcement and fillers are usually tailored to the particular end use.

Preferred strategies for managing manufacturing and end of life product waste are, in order of preference:
i) prevent waste generation during manufacture;
ii) reuse a product;
iii) recycle material;
iv) incinerate waste (with or without energy recovery);
v) disposal in landfill.

According to one of its aspects, the present invention provides a method of recycling a composite material according to claim 1. Further aspects are defined in other independent claims and in the description herein. The dependent claims define preferred or alternative embodiments.

According to one aspect, the present invention provides a method of recycling a composite material which comprises a mineral portion maintained within a thermoset resin, wherein the thermoset resin makes up at least 30 wt %, preferably between 40 wt % and 60 wt %, of the composite material; and
wherein the mineral portion comprises glass fibres, notably glass fibres which comprise

| | Quantity wt % | Preferred quantity wt % |
|---|---|---|
| SiO₂ | ≥52 and ≤68 | ≥52 and ≤62 |
| Al₂O₃ | ≥10 and ≤30 | ≥12 and ≤16 |
| CaO | ≥0 and ≤25 | ≥16 and ≤25 |
| MgO | ≥0 and ≤12 | ≥0 and ≤5 |
| B₂O₃ | ≥0 and ≤10 | ≥0 and ≤2 |
| Li₂O + Na₂O + K₂O | ≥0 and ≤2 | |
| TiO₂ | ≥0 and ≤1.5 | |
| total iron expressed as Fe₂O₃ | ≥0 and ≤1 | ≥0.05 and ≤1 |
| fluoride | ≥0 and ≤1 | |

wherein the method comprises:
introducing the composite material, notably in granulated form, into a mineral melt in a melter wherein heat energy is provided to the mineral melt by one or more submerged combustion burners;
providing additional heat energy to the mineral melt by combustion of the thermoset resin of the composite material within the mineral melt; and
melting and incorporating the mineral portion of the composite material in the mineral melt by heat transfer from the mineral melt;
withdrawing a portion of the melt incorporating from the melter; and
transforming the portion of the melt withdrawn from the melter into a man made vitreous product.

It has been found that this particular type of composite material can be recycled in a submerged combustion melter by combustion of its thermoset resin portion to release energy and incorporation of its mineral portion in to a man made vitreous product. This provides a specific and highly advantageous waste management route that can be used to simultaneously recover energy from thermoset resin portion and re-use the mineral portion of such materials in new products.

Unless otherwise stated, the quantity of constituents of the mineral portion of the composite material, the melt and the man made vitreous product are expressed as oxides, irrespective of the form in which they are actually present. For example, indication of a quantity of CaO is an indication of the total quantity of Ca present, expressed in the form CaO, including notably all Ca present in the form of calcium oxide and all Ca present in the form of calcium carbonate.

The composite material may consist of the thermoset resin and the mineral portion. The composite material may comprise:
≥25 wt % or ≥30 wt % and/or ≤50 wt % or ≤40 wt % thermoset resin; and/or
a mineral portion which makes up ≥30 wt % or ≥40 wt % or ≥50 wt % and/or ≤70 wt % or ≤60 wt % of the composite material.
One preferred type of composite material comprises 30 to 40 wt % thermoset resin and 60 to 70 wt % mineral portion. The glass fibres may make up ≥8 wt % ≥15 wt % or ≥20 wt % and/or ≤40 wt % or ≤30 wt % of the composite material. Waste management of these types of composite materials has previously been problematic.

The quantity of SiO₂ in the glass fibres may be ≥52 wt % and ≤56 wt %. The quantity of SiO₂ in the glass fibres may be ≥54 wt %, ≥55 wt % or ≥56 wt % and/or ≤61 wt %, ≤60 wt %, or ≤58wt %. The quantity of Al₂O₃ in the glass fibres may be ≥12.5 wt % or ≥13 wt % and/or ≤15 wt % or ≤14wt %. The quantity of CaO in the glass fibres may be ≥20 wt % or ≥21 wt % and/or ≤24.5 wt % or ≤23 wt %. The quantity of MgO in the glass fibres may be ≥0.5 wt % or ≥1 wt % and/or ≤5 wt % or ≤3 wt %. The quantity of total iron expressed as Fe₂O₃ in the glass fibres may be ≥0.001 wt % or ≥0.05 wt % or ≥0.1 wt % and/or ≤0.6 wt %, or ≤0.5 wt %. The quantity of B₂O₃ in the glass fibres may be: ≥5 wt % and ≤10 wt %; ≥4.5 wt % and ≤7.5 wt %; or ≥0.25 wt % and ≤3.5 wt %; or ≤0.05 wt %.

In one embodiment, the glass fibres comprise
53 to 56 wt % SiO₂, and
12 to 16 wt % Al₂O₃, and
20 to 24 wt % CaO, and
0 to 2 wt % MgO, and
4 to 8 wt % B₂O₃ and
0.5 to 1.8 wt % of the combination of Li₂O+Na₂O+K₂O, and
0 to 0.5 wt % TiO₂, and
0.005 to 0.75 wt % total iron expressed as Fe₂O₃.

In another embodiment, the glass fibres comprise
55 to 57 wt % SiO₂, and
12 to 15 wt % Al₂O₃, and
23 to 26 wt % CaO, and
1 to 4.5 wt % MgO, and
0.01 to 2.5 wt % B₂O₃ and
0.5 to 1.8 wt % of the combination of Li₂O+Na₂O+K₂O, and
0.01 to 1.5 wt % TiO₂, and
0.005 to 0.75 wt % total iron expressed as Fe₂O₃.

In a further embodiment, the glass fibres comprise
58 to 62 wt % SiO₂, and
11.5 to 14.5 wt % Al₂O₃, and
20 to 24 wt % CaO, and
1.5 to 5 wt % MgO, and
0.01 to 2.5 wt % B₂O₃ and
0.5 to 1.8 wt % of the combination of Li₂O+Na₂O+K₂O, and
0.01 to 1.5 wt % TiO₂, and
0.005 to 0.75 wt % total iron expressed as Fe₂O₃.

The glass fibres may comprise
52 to 62 wt %, notably 55 to 60 wt % SiO₂, and
21 to 30 wt %, notably 23 to 28 wt % Al₂O₃, and
6 to 17 wt %, notably 8 to 15 wt % CaO, and
2 to 9 wt %, notably 4 to 7 wt % MgO, and
0 to 1 wt %, notably 0 to 0.35 wt % B₂O₃ and
0 to 2 wt %, notably 0 to 1 wt % of the combination of Na₂O+K₂O, and
0 to 1 wt %, notably 0 to 0.5 wt % total iron expressed as Fe₂O₃, and
0 to 1 wt %, notably 0 to 0.3 wt % fluoride.

Alternatively, the glass fibres may comprise
62 to 68 wt %, notably 64 to 66 wt % SiO₂, and
22 to 27 wt %, notably 24 to 25 wt % Al₂O₃, and
8 to 12 wt %, notably 9.5 to 10 wt % MgO, and
0 to 1 wt %, notably 0 to 0.2 wt % CaO, and
0 to 1 wt %, notably 0 to 0.2 wt % of the combination of Na₂O+K₂O, and
0 to 0.5 wt %, notably 0 to 0.1 wt % total iron expressed as Fe₂O₃.

In addition to the glass fibres, the mineral portion of the composite material may comprise one or more fillers or additives, notably in the form of particles, generally fine grained particles. Such fillers or additives may comprise carbonates, calcium carbonate, calcium oxide, limestone, ground limestone, marble, dolomite, chalk, precipitated chalk, talc and combinations thereof. The filler(s), particularly the calcium carbonate filler(s) may be present in an amount with is ≥200 phr, ≥250 phr or ≥250 phr and/or ≤500 phr, ≤450 phr or ≤400 phr. The filler(s), particularly the calcium carbonate filler(s) may have a mesh size such that at least 80 wt %, preferably at least 90 wt % has a mesh size which is ≥15, ≥20 or ≥30 and/or ≤150, ≤120 or ≤100. In one advantageous embodiment, the mineral portion of the composite material comprises glass fibres and fillers and comprise at least 10 wt % SiO₂ and at least 30 wt % CaO. Alternatively or additionally, such fillers or additives may comprise one or more material selected from clays, nano-clays and kaolin. The fillers and/or additives, notably in particulate form, may make up ≥30 wt % or ≥40 wt % or ≥50 wt % and ≤70 wt % or ≤60 wt % of the composite material.

The composite material may comprise bulk-moulding compound (BMC), notably cured bulk-moulding compound. Bulk-moulding compound (BMC) is a ready to mould, glass-fibre reinforced thermosetting material used, for example in injection moulding and compression moulding. The thermosetting resin of the bulk-moulding compound may comprise polyester resin, vinyl ester or epoxy resin. Such bulk-moulding compound (BMC) is commonly used in the manufacture of automotive parts and household articles and the ability to recycle significant portions of such mass-produced articles is particularly advantageous. The composite material may comprise sheet moulding compound (SMC), notably cured sheet moulding compound.

The mineral portion of the composite material may comprise:

| | Quantity in wt % | Preferred quantity in wt % |
|---|---|---|
| SiO₂ | 10-30 | 10-25 |
| Al₂O₃ | 0-10 | 2-8 |
| FeO₂ | 0-2 | 0.02-0.3 |
| CaO | 50-90 | 60-85 |
| MgO | 0-3 | 0.05-3 |
| Na₂O | 0-3 | 0.05-2 |
| K₂O | 0-3 | 0.05-2 |
| B₂O₃ | 0-6 | 0-4 |
| TiO₂ | 0-3 | 0.05-1 |

The mineral portion of the composite material may comprise:

| | Quantity in wt % | Preferred quantity in wt % |
|---|---|---|
| SiO₂ | 18-23 | 19-22 |
| Al₂O₃ | 4-6 | 4-6 |
| FeO₂ | 0-0.5 | 0.02-0.2 |
| CaO | 60-80 | 65-75 |
| MgO | 0.2-2 | 0.4-2 |
| Na₂O | 0-1 | 0.05-0.5 |
| K₂O | 0-1 | 0.02-0.5 |
| B₂O₃ | 0-4 | 1-3.5 |
| TiO₂ | 0-1 | 0.02-0.5 |

The mineral portion of the composite material may comprise:

| | Quantity in wt % | Preferred quantity in wt % |
|---|---|---|
| SiO₂ | 12-17 | 13-16 |
| Al₂O₃ | 4-6 | 4-6 |
| FeO₂ | 0-0.5 | 0.02-0.2 |
| CaO | 65-85 | 70-85 |
| MgO | 0.2-2 | 0.4-2 |
| Na₂O | 0-1 | 0.05-0.5 |
| K₂O | 0-1 | 0.02-0.5 |
| B₂O₃ | 0-4 | 0.5-2.5 |
| TiO₂ | 0-1 | 0.02-0.5 |

In one or more of the aforementioned mineral portions, the indication of the quantity of CaO is an indication of the quantity present after calcination to convert any calcium carbonate to calcium oxide (with loss of carbon dioxide).

The glass fibres may have a composition comprising

| | Quantity wt % | Preferred quantity wt % |
|---|---|---|
| SiO₂ | ≥52 and ≤68 | ≥52 and ≤62 |
| Al₂O₃ | ≥10 and ≤30 | ≥12 and ≤16 |
| CaO | ≥0 and ≤25 | ≥16 and ≤25 |
| MgO | ≥0 and ≤12 | ≥0 and ≤5 |
| B₂O3 | ≥0 and ≤10 | ≥0 and ≤2 |
| Li₂O + Na₂O + K₂O | ≥0 and ≤2 | |
| TiO₂ | ≥0 and ≤1.5 | |
| total iron expressed as Fe₂O₃ | ≥0 and ≤1 | ≥0.05 and ≤1 |
| fluoride | ≥0 and ≤1 | |

The composite material may have a calorific value which is ≥200 J/g, ≥300 J/g or ≥400 J/g and/or ≤2000 J/g or or ≤2000 J/g. The use of a composite materials having such calorific values provides suitable combustion characteristics in the melter.

Advantageously, the melt in the melter and/or the melt withdrawn from the melter has a composition selected from:

a) a composition comprising:

| | Quantity wt % |
|---|---|
| SiO₂ | ≥30 and ≤55 |
| Al₂O₃ | ≥10 and ≤30 |
| CaO + MgO | ≥20 and ≤35 |
| total iron expressed as Fe₂O₃ | ≥4 and ≤14 |
| Na₂O + K₂O | ≥0 and ≤8 |
| (Na₂O + K₂O)/(CaO + MgO) | <1 |

b) a composition comprising:

| | Quantity wt % |
|---|---|
| SiO₂ | ≥30 and ≤55 |
| Al₂O₃ | ≥10 and ≤30 |
| CaO + MgO | ≥8 and ≤23 |
| total iron expressed as Fe₂O₃ | ≥4 and ≤14 |
| Na₂O + K₂O | ≥4 and ≤24 |

c) a composition comprising

| | Quantity wt % |
|---|---|
| SiO₂ | ≥55 and ≤75 |
| Al₂O₃ | ≥0 and ≤5 |
| CaO + MgO | ≥5 and ≤20 |
| Na₂O + K₂O | ≥5 and ≤20 |
| total iron expressed as Fe₂O₃ | ≥0 and ≤2 |
| (Na₂O + K₂O)/(CaO + MgO) | >1 |

d) a composition comprising

| | | Preferred |
|---|---|---|
| Constituent | Quantity wt % | quantity wt % |
| SiO₂ | ≥52 and <68 | ≥52 and ≤62 |
| Al₂O₃ | ≥10 and ≤30 | ≥12 and ≤16 |
| CaO | ≥0 and ≤25 | ≥16 and ≤25 |
| MgO | ≥0 and ≤12 | ≥0 and ≤5 |
| B₂O3 | ≥0 and ≤10 | ≥0 and ≤2 |
| Li₂O + Na₂O + K₂O | ≥0 and ≤2 | |
| TiO₂ | ≥0 and ≤1.5 | |
| total iron expressed as Fe₂O₃ | ≥0 and ≤1 | ≥0.05 and ≤1 |
| fluoride | ≥0 and ≤1 | |

The mineral portion of the composite material is particularly useful for providing one or more components of such compositions, notably in combination with other batch materials whose quantity is suitable adjusted to provide the composition desired. Such other batch materials, notably when it is desired to produce a melt for manufacture of stone wool fibres, may comprise one of more material selected from: basalt, gabbro, dolomite, calcined alumina and recycled materials including stone wool fibers and slag. Such other batch materials, notably when it is desired to produce a melt for manufacture of glass wool fibers may be selected from silica sand, feldspar, nepheline syenite, aplite, calcined alumina, hydrated alumina, soda-ash, limestone, dolomite, magnesite, recycled glass bottles, recycled glass sheets, borax pentahydrate, borax decahydrate and anhydrous borax.

The melt withdrawn from the melter is preferably fiberized; the man made vitreous product may be man made vitreous fibres, for example mineral fibres, glass fibres or stone wool fibres. Preferably, the melt is fiberized without a separate refining step. The man made vitreous product may be selected from flat glass, container glass, continuous fibres and mineral wool.

The composite material may make up ≥5 wt % or ≥8 wt % and/or ≤30 wt %, ≤20 wt % or ≤17 wt %, of the batch materials introduced in to the melter. Such quantities i) provide a sufficient quantity for the process to offer significant recycling of the composite materials and for the energy provided by combustion of the resin of the composite material to contribute significantly to the total energy required for the production of the melt and ii) avoid deleterious effects upon the production of the melt.

The composite material preferably comprises composite material in granulated form, notably having a particle distribution size, determined by sieving, in which at least 80 wt % and preferably at least 90 wt % of the granulated composite material has a particle size in the range 3 mm to 20 mm, notable in the range 5 mm to 10 mm. Such granular form facilities preparation and feeding of the composite material and facilitates its incorporation in the production of the melt without deleterious effects.

It has surprisingly been found that the present method of recycling can be carried out without the production of undesired emissions or VOCs. Notably, the exhaust gasses, prior to any filtration or purification preferably comprise:
≤30 mg/m³ ,notably ≤20 mg/m³, dust; and/or
≤200 mg/m³ ,notably ≤100 mg/m³, NOx (expressed as NO2); and/or
≤40 mg/m³ ,notably ≤20 mg/m³, CO; and/or
≤10 mg/m³ ,notably ≤5 mg/m³, total organic carbon; and/or
≤5 mg/m³ ,notably ≤4 mg/m³, HF; and/or
≤30 mg/m³ ,notably ≤10 mg/m³, HCI; and/or
≤10 mg/m³ ,notably ≤2 mg/m³, Acetaldehyde; and/or
≤3 mg/m³ ,notably ≤2 mg/m³, Benzene; and/or
≤80 mg/m³ ,notably ≤2 mg/m³, Styrene.

Preferably, the exhaust gasses reach a temperature of at least 610° C., notably at least 650° C. prior to possible dilution and evacuation from the melter. Such a temperature may be used to control the nature of the emissions, for example, to provoke combustion of any CO.

According to another aspect, the present invention provides a method of manufacturing a mineral melt comprising:
introducing solid batch materials into a mineral melt in a melter, melting the solid batch materials in the melt by submerged combustion and withdrawing a portion of the melt from the melter,
wherein the solid batch materials comprise a granulated composite material, notably at least 2 wt % of a granulated composite material,
wherein the granulated composite material comprises a mineral portion maintained within a thermoset resin,
wherein the mineral portion comprise at least 10 wt % SiO2 and at least 30 wt % CaO; and
wherein the thermoset resin makes up at least 30 wt %, preferably between 40 wt % and 60 wt %, of the composite material.

According to a further aspect, the present invention provides a method of manufacturing a mineral melt comprising:
introducing solid batch materials into a mineral melt in a melter, melting the solid batch materials in the melt by submerged combustion and withdrawing a portion of the melt from the melter,
wherein the solid batch materials comprise at least 2 wt % of a granulated material having:
a) a particle distribution size, determined by sieving, in which at least 80 wt % and preferably at least 90 wt % of the granulated material has a particle size in the range 3 mm to 20 mm, notable in the range 5mm to 10 mm; and
b) a calorific value of at least 300 J/g, notably between 300 and 1000 J/g.
The said granulated material may be a composite material as described herein, notably making up ≥5 wt % or ≥8 wt % and/or ≤30 wt %, ≤20 wt % or ≤17 wt %, of the batch materials introduced in to the melter. It has surprisingly been found that the inclusion of such granulated material in the solid batch materials may be used to affect, control or reduce bubble size in a submerged combustion mineral melter during manufacture of a mineral melt. Whilst not wishing to be bound by theory, it is believed that distribution of the said granulated material through the mineral melt provides distributed sites that seed the formation of bubbles during submerged combustion and that this effect is particularly enhanced by appropriate selection of: size of the granulated material; and/or a resin or organic portion of the particles which decomposes and provides energy to the melt at a plurality or distributed sites; and/or a mineral portion, notably a mineral fibre portion, of the granulated material which helps maintain integrity of individual particles of granulated material within the melt for a suitable amount of time before the granulated material is incorporated in to the melt. Such control and/or reduction in bubble size in the submerged combustion melt may be advantageously used to enhance mixing within the melt and/or to control or reduce sputtering of the melt from the melt surface and/or to control or reduce pulsing or variations in the outflow volume or speed of the melt.

It is preferred that at least during melting and incorporating the mineral portion of the composite material in the mineral melt by heat transfer from the mineral melt an essentially toroidal melt flow pattern is generated in the melt of molten material, the central axis of revolution of the toroidal flow being essentially vertical and the said toroidal melt flow comprising major centrally inwardly convergent flows at the melt surface This facilitates incorporation of the composite material in to the melt. The essentially toroidal melt flow pattern may be simulated by means of Computational Fluid Dynamics analysis; the computational fluid dynamics model code may be ANSYS R14.5, taking into consideration the multi-phase flow field with phases ranging from solid batch material to liquid melt, to various gas species associated with both the combustion of fuel and oxidant by the burners as well as those generated in the course of the batch-to-melt conversion process.

In the proximity of the central axis of revolution of said toroidal flow pattern, the flow vectors preferably change orientation showing downwardly orientation(s), hence reflecting significant downward movement of the melt in proximity of the said axis. In preferred arrangements, the melt moves downwardly in the center at proximity of the axis of revolution and is recirculated in an ascending movement back to the melt surface, thus defining an essentially toroidal flow pattern. At the melter bottom, the flow vectors preferably change orientation showing orientation(s) which are outward and then upwards again. The inwardly convergent flow vectors at the melt surface advantageously show a speed up to about 2 m/s; the downward oriented speed vectors at proximity of the vertical central axis of revolution may show a downward speed component up to about 2 m/s.

The toroidal melt flow pattern may be obtained by arrangement of the submerged combustion burners at the melter bottom, in a substantially annular burner zone, imparting a substantially vertically upward directed speed component to the flame and combustion gases, for example at a distance between adjacent burners of about 250 to 1250 mm, advantageously 500 to 900 mm, preferably about 600 to 800, even more preferably about 650 to 750 mm.

The melter is preferably a submerged combustion melter. As used herein, the term submerged combustion melter means a melter in which the majority, notably at least 80%, 90% or 95%, of the energy required to melt batch materials is provided by burners which release combustible materials, notably natural gas and oxygen, and/or combustion products thereof directly in to the melt, ie below the surface of the melt.

An embodiment of the invention will now be described, by way of example only, with reference to the accompanying drawings of which:

FIG. 1 is a horizontal cross-sectional plan view of a pilot melter;

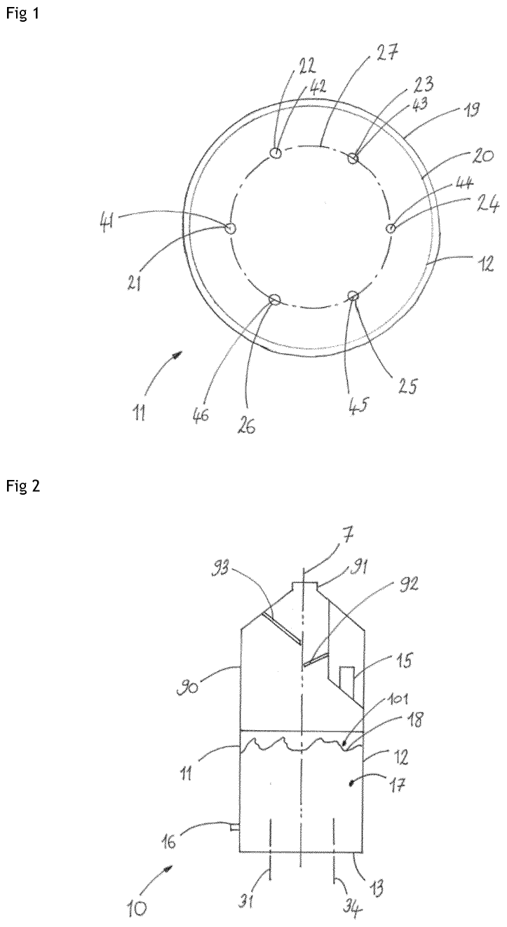

FIG. 2 shows a vertical section through the melter of FIG. 1;

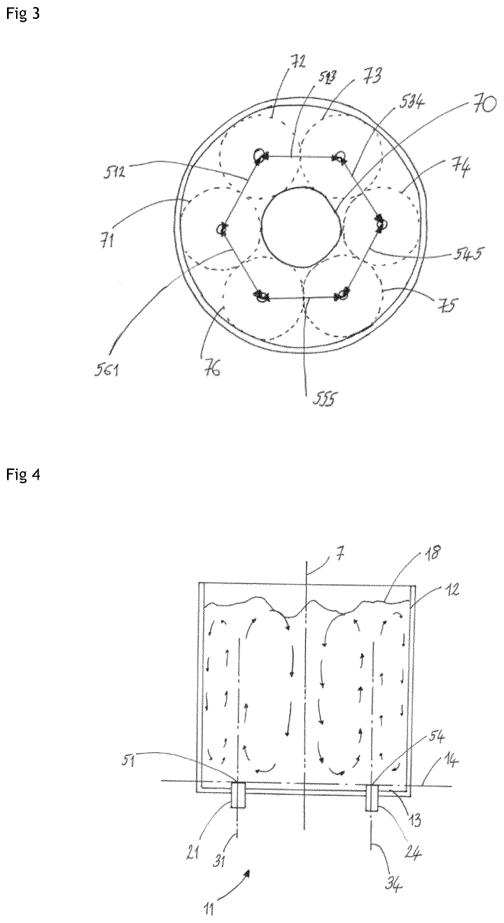

FIG. 3 is a schematic representation of the burner layout;

FIG. 4 is a schematic representation of a preferred toroidal flow pattern;

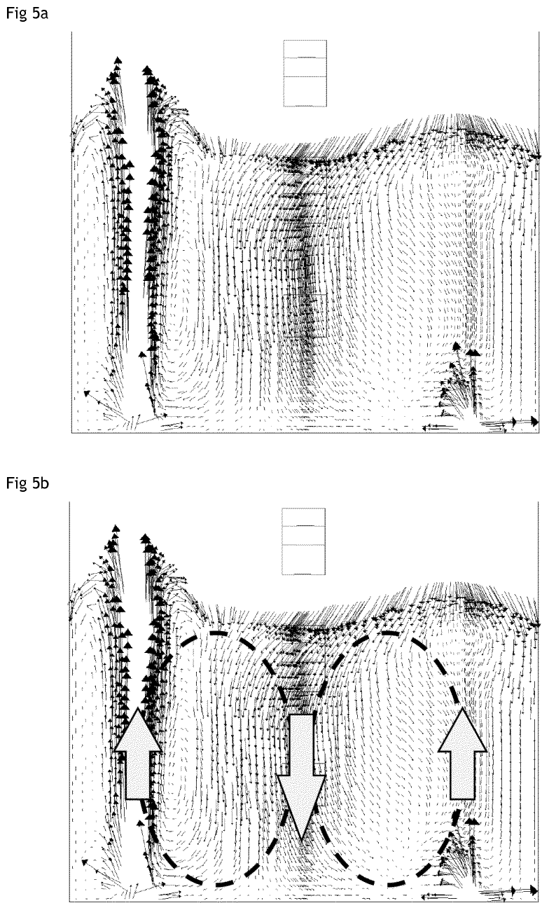

FIGS. 5a and 5b are representations of a toroidal flow pattern generated by computer simulation;

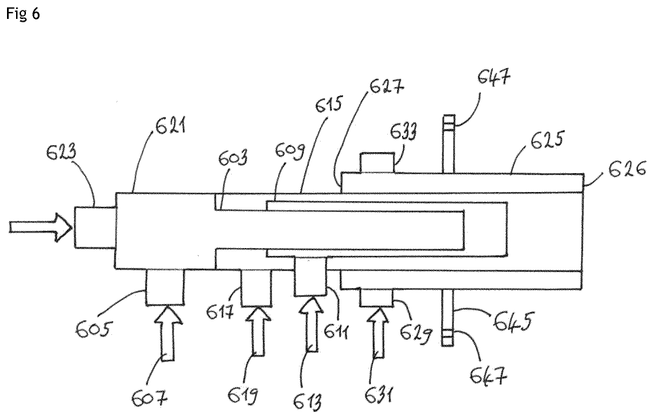

FIG. 6 is a schematic cross-section through a burner.

Four different melts were run in a pilot test using the submerged combustion melter described below using different quantities of the following two batch materials:

Batch material A: glass cullet having the following composition:

| | Quantity wt % |
|---|---|
| SiO₂ | 40.3 |
| Al₂O₃ | 16.8 |
| CaO | 18.1 |
| MgO | 11.0 |
| total iron expressed as Fe₂O₃ | 8.0 |
| Na₂O | 3.0 |
| K₂O | 0.7 |
| TiO₂ | 1.6 |
| P₂O₃ | 0.2 |

Batch material B: cured bulk moulding compound composite material comprising a mineral portion making up about 82 wt % and maintained within a thermoset resin portion making up about 18 wt %, the mineral portion comprising glass fibres and the mineral portion comprising:

| | Quantity in wt % |
|---|---|
| SiO₂ | 18-23 |
| Al₂O₃ | 4-6 |
| FeO₂ | 0-0.5 |
| CaO | 60-80 |
| MgO | 0.2-2 |
| Na₂O | 0-1 |
| K₂O | 0-1 |
| B₂O3 | 0-4 |
| TiO₂ | 0-1 |

The quantity of resin was determined by LOI at 550° C. ie determining the reduction of mass when the temperature is raised to 550° C. The composition of the mineral portion was measured after raising the temperature to 950 ° C. which resulted in calcination of the CaCO₃ present in to CaO with loss of CO₂.

The four melts were as follows:

| | |
|---|---|
| Batch material A | Batch material B |

| | | | | |
|---|---|---|---|---|
| Melt 1 | 100 | wt % | 0 | wt % |
| (comparative example) | | | | |
| Melt 2 | 95 | wt % | 5 | wt % |
| Melt 3 | 90 | wt % | 10 | wt % |
| Melt 4 | 85 | wt % | 15 | wt % |

In each case a portion of the melt was withdrawn from the melter. The following observations were made:
a) each test produced a good quality melt with no deterioration in melt quality being observed when increasing the quantity of batch material B;
b) each addition of the quantity of batch material B increased the temperature of the melt indicating the provision of energy to the melt from combustion of the resin portion of batch material B; this allowed adjustment to reduce the amount of natural gas provided to the submerged combustion burners;
c) all flue emissions were within desired limits.

The pilot melter configuration is described in more detail below.

The melter 10 illustrated in FIGS. 1, 2 and 3 comprises a melting chamber 11, that is to say a portion of the melter 10 adapted to retain and melt a heated melt 17, for example of a composition for manufacturing stone wool or glass wool fibre, and an upper chamber 90.

The illustrated melting chamber 11 is cylindrical and has a vertical central melting chamber axis 7, a periphery 12 defined by its internal circumference which has a diameter of about 2 m, a base 13 forming the lower ender of the cylinder and an open end at the upper end of the cylinder which communicates with the upper chamber 90.

The upper chamber 90 is provided with:
a chimney 91 for evacuation of the gasses from the melting chamber 11;
baffles 92, 93 that block access to any melt projections which may be thrown up from the surface of the melt 18; and
a raw material feeder 15 arranged at the level of the upper chamber 90 to load fresh raw material into the melter 10 at a batch introduction position 101 located above a surface 18 of the melt and close to the peripheral side wall 12 of the melter.

The feeder 15 comprises a screw or other horizontal feeder which transports a raw material mix to a hopper which may be opened and closed by a piston. In the pilot test batch, material A and batch material B were pre-mixed to the desired quantities prior to being fed in to the melter.

The melter has a double steel peripheral wall 19, 20 having a cooling liquid, preferably water, circulating through its interior at a flow rate which is sufficient to maintain a desired temperature of the melter and of the cooling fluid and withdraw energy from the inside peripheral wall 12 such that a portion of the melt can solidify or partially solidify on the internal peripheral wall to form a boundary layer.

If desired the melter may be mounted on dampers to absorb vibrations.

Six submerged burners 21, 22, 23, 24, 25, 26 are arranged, equally spaced around a substantially circular burner line 27 which is concentric with the central vertical melting chamber axis 7 and has a diameter of approximately 1.4 m. Each submerged combustion burner has a respective central burner axis 31,32,33,34,35,36 and one or more outlet nozzles 41,42,43,44,45, 46 from which flames and/or combustion fluids are projected in to the melt 17. Each burner is positioned at a substantially identical adjacent burner spacing 512, 523, 534, 545, 556, 561 with respect to each of its two closest adjacent burner positions. The burner nozzles 41, 42, 43, 44, 45, 46 in the illustrated embodiment are arranged to project slightly above the base 13 of the melting chamber, each at the same vertical height as a burner positioning plane 14.

Each central burner axis 31,32,33,34,35,36 has a respective burner axis circle 71,72,73,74,75,76 which extends around the central burner axis and has a radius r1,r2,r3,r4,r5,r6 which is substantially equal to the distance between the central burner axis and the peripheral wall 12 of the melting chamber. These burner axis circles define a central zone 70 at a positioning plane 14 having a diameter of at least 250 mm.

The melt 17 may be withdrawn from the melting chamber through a controllable outlet opening 16 located in the melter chamber periphery side wall 12, close to the melter bottom 13, substantially opposite the raw material feeder 15.

The submerged burners 21,22,23,24,25,26 are tube in tube burners, sometimes referred to as concentric pipe burners, operated at gas flow or speed in the melt of 100 to 200 m/s, preferably 110 to 160 m/s. The burners generate combustion of fuel gas and air and/or oxygen within the melt. The combustion and combustion gases generate high mixing and high rates of heat transfer within the melt before they escape from the melt into the upper chamber 90 and are exhausted through the chimney 91. These hot gases may be used to preheat raw material and/or the fuel gas and/or oxidant (air and/or oxygen) used in the burners. The exhaust fumes are preferably cooled, for example by dilution with ambient air, and/or filtered prior to release to the environment.

It is preferable that the arrangement generates a toroidal melt flow as illustrated in FIG. 4 in which the melt follows an ascending direction close to the central burner axis of each submerged burner, flows inwardly towards the vertical central melting chamber axis 7 at the melt surface 18 and then flows downwards in an substantially cylindrical portion of the melting chamber which projects along the vertical central melting axis 7 from the central melting zone 70. Such a toroidal flow generates high mixing in the melt, ensures good stirring of the melt and absorption of fresh raw material and allows for appropriate residence time of the material in the melter, thereby avoiding premature outflow if insufficiently melted or mixed raw materials.

The burners generate an ascending movement of melt in their proximity and a circulation within the melt. In one preferred embodiment, each burner axis is vertically oriented or inclined at an angle of no more than 15° from vertical, advantageously towards the center of the melter, in order to favour the generation of toroidal flow as taught above.

To further improve homogeneity of the melt, one or more burners may impart a tangential velocity component to its combustion gases, hence imparting a swirling movement to the melt flow, in addition to the toroidal flow pattern described above. For that purpose, the central burner axis of one or more burners may form a swirl angle of at least 1° with respect to a plane which is perpendicular to burner positioning plane 14 and which passes through the vertical central melting chamber axis 7 and the burner position.

The melter may be equipped with an auxiliary burner (not shown) notably for temporary use for example for preheating the melter when starting, in the case of malfunction of one of the submerged burners described above or in other cases where additional heat is temporarily required. The auxiliary burner is advantageously mounted on a rail so that it can be guided into an opening provided in the melter peripheral wall 12, the opening being closed when the auxiliary burner is not in use.

The internal melter wall 12 advantageously comprises a multitude of tabs or pastilles (not shown) projecting inside the melter chamber 11. It is believed these projections favour the formation and fixation of a solidified melt layer on the cooled wall 12, which constitutes an insulating layer. In the case of a glass melt for instance, glass solidifies on the cooled wall and forms an insulating boundary layer. Glass is thus melted in glass and the melt is not contaminated with erosion residues of any refractory material.

An example of a toroidal flow pattern is illustrated in FIGS. 5a and 5b. Melt follows an ascending direction close to submerged burners arranged on a substantially circular burner line, flows inwardly towards the center of the relevant circle line, at the melt surface, and then downwards again, in proximity of the said center. Such toroidal flow ensures good stirring of the melt and absorption of fresh raw material.

Additional flow circulations may take place. Melt may flow between burners and side wall. Other flows may take place between burners. These are not necessarily disadvantageous and, to the contrary, may even be desirable.

The toroidal flow pattern of FIGS. 5a and 5b has been generated by computer simulation, taking into consideration common Eulerian, multi-phase fluid dynamics modeling techniques familiar to those skilled in the art. The computational fluid dynamics code selected for this exercise advantageously is ANSYS R14.5. The model advantageously takes into consideration the multi-phase flow field spanning the full range of mixture fractions from dispersed gas bubbles in liquid to distributed solid particles or liquid droplets in gas, with the solid phase batch undergoing a multi-phase, thermo-chemical conversion reaction to produce liquid phase melt and gas phase species. The system utilizes submerged combustion of fuel and oxygen gas phase species to produce carbon dioxide and water vapor. In addition, the melt viscosity is highly temperature dependent. The complex batch-to-melt conversion process may be modeled with the reaction step following an Arrhenius rate law

Batchsolid+ΔHr>Meltliquid+0.074CO2+0.093H2O

with Arrhenius reaction rate k=AT2 e(−E/T)

the Arrhenius rate constants being taken from the literature (see A Ungan and R Viskanta, “Melting behavior of continuously charged loose batch blankets in glass melting furnaces”, Glastech. Ber. 59 (1986) Nr. 10, p. 279-291). The molar ratios of the batch gases in this reaction are consistent with the production of 0.0503 kg CO2 and 0.0258 kg H2O from 1 kg batch. The heat of reaction accounts for all energy required to convert batch into liquid phase melt and gas species, including both chemical conversion and phase change heat requirements. Physical properties for the batch and melt may be taken from literature as far as available and/or may be determined by methods known per se. Radiation heat exchange is simulated using the Discrete Ordinates Radiation model, with the gas phase absorption coefficient estimated using the Weighted Sum of the Gray Gases model, the melt absorption coefficient specified (to a high value of 300 l/m) and the batch absorption coefficient advantageously specified so as to render it opaque relative to the other fluids. While the melt is assigned as the primary fluid phase and the gases are assigned as the secondary fluid phase having uniform bubbled diameter of 5 mm. Momentum exchange among the liquid and gas phases above the anticipated bath height is artificially suppressed.

For computational fluid dynamics modeling of the melter of FIGS. 5a and 5b a batch inlet of 0.833 kg/s at inlet temperature of 27° C. was set in the model, consistent with a 72 T/day production rate. Burner inlet was set as follows: firing rate=5.2 WM (based on LHV); mass flow rate of 0.109 kg/s per burner; molar composition=0.11 C3H8, 0.89 O2; inlet temperature of 15° C. The walls were modeled by specifying a uniform surface temperature of 152° C. behind a thickness of solidified glass which serves as an insulator. The thermal conductivity specified for the glass is 1 W/mK. The glass thickness, nominally 15 mm, is varied to achieve an average heat flux of from 50 to 70 kW/m2.

FIG. 6 illustrates one preferred submerged combustion burner which comprises:
an internal tube 603 connected through internal tube connector 605 to a source of oxygen containing gas 607;
a middle tube 609, surrounding the internal tube 603, connected through a middle tube connector 611 to a source of fuel gas 613; and;
an outer tube 615 connected through outer tube connector 617 to a source of oxygen containing gas 619.

The three concentric tubes 603, 609 and 615 are all closed at one end of the burner and open at an opposite nozzle end of the burner. At the closed end 621, the inner tube comprises a connector 623 for connection to a nitrogen source, which may be closed by an appropriate stopper or valve. The nitrogen connection is designed to blow high pressure nitrogen through the burner when firing is interrupted to prevent melt flow into the burner.

At least part of the burner length may be enveloped by a further cooling tube 625, closed at both ends 626, 627 and comprising an inlet 629 connected to a source of cooling fluid 631, preferably water, and an outlet 633 connected to a cooling fluid circuit (not shown). This arrangement allows for proper cooling of the burner when in use. The annular space between cooling tube 625 and outer tube 615 may further comprise baffles (not shown) to generate a predesigned liquid flow within that space to optimize the cooling effect on the burner.

The open end of the outer tube 615 connected to an oxygen containing gas protrudes beyond the open end of the middle tube 609 connected to fuel gas. The open end of the middle tube 609 protrudes beyond the open end of the internal tube 603 connected to a source of oxygen containing gas. The cooling tube 625 containing the cooling fluid extends up to the open end of the outer tube 615 to cool the burner end.

The tubes 603, 609 and 615 are assembled with each other at the closed end of the burner. It may be advantageous to also connect the relevant tubes to each other at or towards the open end. This may be achieved by assembling centering devices (not shown) located in the space between inner tube 603 and middle tube 609, and between middle tube 609 and outer tube 618. Advantageously at least three such assembling centering devices may be spread over the circumference of the relevant tubes securing the tubes together while leaving sufficient space for the desired gas flow.

Such burners are particularly suitable for use in submerged combustion glass melters. In such cases, said burners or at least their open ends are generally arranged at the bottom of a submerged combustion melter and may slightly extend within the liquid glass bath. Suitable cooling of the end extending into the melt protects the burner from excessive wearing. The burner comprises a flange 645 adapted for securing it into a furnace bottom, for instance by means of screws or other fasteners guided through an appropriate number of flange fastening holes 647 in order to tightly fasten the burner at a furnace bottom.

The submerged burners inject high pressure jets of the combustible gas and oxidant and/or combustion products into the melt sufficient to overcome the liquid pressure and to create forced upward travel of the flame and combustion products. Preferably the velocity of the combustion gases is in the range of about 60 to 300 m/s, preferably 100 to 200, more preferably 110 to 160 m/s. Glass melt particles reach speeds of up to 2 m/s.

A melter according to the invention is particularly advantageous in a glass fiber, glass wool or stone wool production line because its efficiency provides for low energy consumption and its flexibility facilitates changes of raw material composition. Ease of maintenance and low capital costs of the melter are also of major interest in building such a production line. The same features also make the melter advantageous in waste and ash vitrification processes.

1.-15. (canceled)

16. A method of recycling a composite material which comprises a mineral portion maintained within a thermoset resin,
wherein the thermoset resin makes up at least 30 wt % of the composite material; and
wherein the mineral portion makes up at least 30 wt % of the composite material and comprises glass fibres which comprise

| | Quantity wt % |
|---|---|
| SiO₂ | ≥52 and ≤68 |
| Al₂O₃ | ≥10 and ≤30 |
| CaO | ≥0 and ≤25 |
| MgO | ≥0 and ≤12 |
| B₂O3 | ≥0 and ≤10 |
| Li₂O + Na₂O + K₂O | ≥0 and ≤2 |
| TiO₂ | ≥0 and ≤1.5 |
| total iron expressed as Fe₂O₃ | ≥0 and ≤1 |
| fluoride | ≥0 and ≤1 |

wherein the method comprises:
introducing batch material(s) into a mineral melt in a melter, wherein the batch material comprise the composite material;
providing heat energy to the mineral melt by one or more submerged combustion burners;
providing additional heat energy to the mineral melt by combustion of the thermoset resin of the composite material within the mineral melt;
melting and incorporating the mineral portion of the composite material in the mineral melt by heat transfer from the mineral melt;
withdrawing a portion of the melt incorporating from the melter; and
transforming the portion of the melt withdrawn from the melter into a man-made vitreous product.

17. The method of claim 16, wherein the mineral portion comprises glass fibres which comprise

| | Quantity wt % |
|---|---|
| SiO₂ | ≥52 and ≤62 |
| Al₂O₃ | ≥12 and ≤16 |
| CaO | ≥16 and ≤25 |
| MgO | ≥0 and ≤5 |
| B₂O3 | ≥0 and ≤2 |
| Li₂O + Na₂O + K₂O | ≥0 and ≤2 |
| TiO₂ | ≥0 and ≤1.5 |
| total iron expressed as Fe₂O₃ | ≥0.05 and ≤1 |
| fluoride | ≥0 and ≤1 |

18. The method of claim 16, wherein introducing the composite material into the mineral melt in the melter comprises introducing the composite material in granulated form.

19. The method of claim 16, wherein the glass fibres make up at least 8 wt % of the composite material.

20. The method of claim 16, wherein the glass fibres make up between 20 wt % and 30 wt % of the composite material.

21. The method of claim 16, wherein the composite material further comprises at least 30 wt % of mineral particulates.

22. The method of claim 16, wherein the mineral portion of the composite material comprise at least 10 wt % SiO₂ and at least 30 wt % CaO.

23. The method of claim 16, wherein at least part of the quantity expressed as CaO is present in the composite material in the form of calcium carbonate.

24. The method of claim 16, wherein the mineral portion of the composite material comprises:

| | Quantity in wt % |
|---|---|
| SiO₂ | 10-30 |
| Al₂O₃ | 0-10 |
| FeO₂ | 0-2 |
| CaO | 50-90 |
| MgO | 0-3 |
| Na₂O | 0-3 |
| K₂O | 0-3 |
| B₂O₃ | 0-6 |
| TiO₂ | 0-3 |

25. The method of claim 16, wherein the mineral portion of the composite material comprises:

| | Quantity in wt % |
|---|---|
| SiO₂ | 10-25 |
| Al₂O₃ | 2-8 |
| FeO₂ | 0.02-0.3 |
| CaO | 60-85 |
| MgO | 0.05-3 |
| Na₂O | 0.05-2 |
| K₂O | 0.05-2 |
| B₂O₃ | 0-4 |
| TiO₂ | 0.05-1 |

26. The method of claim 16, wherein the composite material makes up between 5 wt % and 20 wt % of the batch materials introduced in to the melter.

27. The method of claim 16, wherein the composite material makes up between 8 wt % and 17 wt %, of the batch materials introduced in to the melter.

28. The method of claim 16, wherein the composite material comprises composite material in granulated form having a particle distribution size, determined by sieving, in which at least 80 wt % of the granulated composite material has a particle size in the range 3 mm to 20 mm.

29. The method of claim 16, wherein the composite material comprises composite material in granulated form having a particle distribution size, determined by sieving, in which at least 80 wt % of the granulated composite material has a particle size in the range 5mm to 10 mm.

30. The method of claim 16, wherein the composite material has a calorific value of at least 300 J/g.

31. The method of claim 16, wherein the composite material has a calorific value between 300 and 1000 J/g.

32. The method of claim 16, wherein transforming the portion of the melt withdrawn from the melter in to a man-made vitreous product comprises fiberizing the portion of the melt withdrawn from the melter.

33. The method of claim 16, wherein the melt withdrawn from the melter has a composition selected from (a), (b) and (c) below:
(a) a composition comprising:

| | Quantity wt % |
|---|---|
| SiO₂ | ≥30 and ≤55 |
| Al₂O₃ | ≥10 and ≤30 |
| CaO + MgO | ≥20 and ≤35 |
| total iron expressed as Fe₂O₃ | ≥4 and ≤14 |
| Na₂O + K₂O | ≥0 and ≤8 |
| (Na₂O + K₂O)/(CaO + MgO) | <1 |

(b) a composition comprising

| | Quantity wt % |
|---|---|
| SiO₂ | ≥30 and ≤55 |
| Al₂O₃ | ≥10 and ≤30 |
| CaO + MgO | ≥8 and ≤23 |
| total iron expressed as Fe₂O₃ | ≥4 and ≤14 |
| Na₂O + K₂O | ≥4 and ≤24 |

(c) a composition comprising

| | Quantity wt % |
|---|---|
| SiO₂ | ≥55 and ≤75 |
| Al₂O₃ | ≥0 and ≤5 |
| CaO + MgO | ≥5 and ≤20 |
| Na₂O + K₂O | ≥5 and ≤20 |
| total iron expressed as Fe₂O₃ | ≥0 and ≤2 |
| (Na₂O + K₂O)/(CaO + MgO) | >1 |

34. The method of claim 16, wherein the melt withdrawn from the melter has a composition selected from (d) and (e) below:
(d) a composition comprising

| Constituent | Quantity wt % |
|---|---|
| SiO₂ | ≥52 and ≤68 |
| Al₂O₃ | ≥10 and ≤30 |
| CaO | ≥0 and ≤25 |
| MgO | ≥0 and ≤12 |
| B₂O3 | ≥0 and ≤10 |
| Li₂O + Na₂O + K₂O | ≥0 and ≤2 |
| TiO₂ | ≥0 and ≤1.5 |
| total iron expressed as Fe₂O₃ | ≥0 and ≤1 |
| fluoride | ≥0 and ≤1 |

(e) a composition comprising

| Constituent | Quantity wt % |
|---|---|
| SiO₂ | ≥52 and ≤62 |
| Al₂O₃ | ≥12 and ≤16 |
| CaO | ≥16 and ≤25 |
| MgO | ≥0 and ≤5 |
| B₂O3 | ≥0 and ≤2 |
| Li₂O + Na₂O + K₂O | ≥0 and ≤2 |
| TiO₂ | ≥0 and ≤1.5 |
| total iron expressed as Fe₂O₃ | ≥0.05 and ≤1 |
| fluoride | ≥0 and ≤1 |

35. A method of reducing bubble size in a submerged combustion mineral melter during manufacture of a mineral melt comprising recycling a composite material in the melter according to claim 16.
